(19) United States
(12) Patent Application Publication
(10) Pub. No.: US 2018/0119673 A1
(43) Pub. Date: May 3, 2018

(54) SOLAR COMPRESSION POWER STATION

(71) Applicants: Vardan HOVAKIMYAN, Yerevan (AM); Eduard HOVAKIMYAN, Yerevan (AM)

(72) Inventor: Vardan HOVAKIMYAN, Yerevan (AM)

(21) Appl. No.: 15/566,726

(22) PCT Filed: Apr. 14, 2016
(86) PCT No.: PCT/AM2016/000002

§ 371 Date: Oct. 16, 2017

(30) Foreign Application Priority Data
Apr. 15, 2015 (AM) AM201500047

(51) Int. Cl. F03D 9/00; F03D 9/25

(52) U.S. Cl. CPC F03D 9/007; F03G 6/00; F03D 9/25

(57) ABSTRACT

Invention relates to the field of solar energy. Power station, which has the air stream directional body, at least a pair of generator connected with wind turbines, tough combined greenhouse to the lower end of the body, the external surface of the of which is painted by matt black paint, and due to invention, it (body) is situated on the slope of the mountain, the greenhouse is being realized in the form of body entrance section, and the entrance of which is widened due to the height and width toward body. Before the greenhouse the black color material layer is located on the surface of the earth, and inside there are full of water reservoirs. The power station additionally has electrical air heaters located along the body, heat exchange system and least one horizontal acceleration cell, which is toughly connected with the upper end of the body and has a narrowing transverse cross section. At the free narrowing end of the acceleration cell, a passing cell is situated, at the exit of which a generator fixed to turbine is located. Heat exchange system has a lower radiator, which is located at the body entrance section and an upper radiator; located at the acceleration cell entrance section. Lower and upper radiators are connected with each other by pipes located along the body. The objective of the invention is to rise the EC of the power plant.

### TECHNICAL FIELD

Invention relates to the field of solar energy.

### BACKGROUND ART

The most famous and closest analogy by working principle is the “Solar Tower” project of “Enviro Mission” Australian company of 11.03.2015. http://investorshub.advfn.com/EnviroMission-Ltd-EVOMY-12042/. It has a field of 10 glass greenhouses built on earth's surface, which accumulate solar heat, and there is a pipe (body) up to 1000 m. altitude situated in the center. In greenhouses the heated air is being absorbed in the body having natural traction force creating so called vacuum effect, which in its turn launches the wind turbines situated at the foot of the body.

Imperfections of this power station are;

The bulk of accumulated thermal energy flows away through open body.

Low layout of turbines deprives from ability of getting the most possible speed of wind currents and receiving EC (efficiency coefficient).

The structure is too expensive and economically is not beneficial compared with the traditional power plants.

### DISCLOSURE OF INVENTION

The objective of the invention is to rise the EC of the power plant. The essence of the invention lies in the fact that at solar compression power station, which has the air stream directional body, at least a pair of generator connected with wind turbines, tough combined greenhouse to the lower end of the body, the external surface of the of which is painted by matt black paint, and due to invention, it (body) is situated on the slope of the mountain, the greenhouse is being realized in the form of body entrance section, and the entrance of which is widened due to the height and width toward body. Before the greenhouse the black color material layer is located on the surface of the earth, and inside there are full of water reservoirs. The power station additionally has electrical air heaters located along the body, heat exchange system and least one horizontal acceleration cell, which is toughly connected with the upper end of the body and has a narrowing transverse cross section. At the free narrowing end of the acceleration cell, a passing cell is situated, at the exit of which a generator fixed to turbine is located. Heat exchange system has a lower radiator, which is located at the body entrance section and an upper radiator; located at the acceleration cell entrance section. Lower and upper radiators are connected with each other by pipes located along the body.

The essence of the invention lies in the fact that additional water-filled reservoirs are located along the body.

The essence of the invention lies in the fact that it has an additional upper radiator located around the acceleration cell.

The essence of the invention lies in the fact that the free end of acceleration cell is realized in the form of controlled, variable cross section nozzle.

Using slopes' dimensions greenhouses and body are being joined and act as a working form of the body. Besides it does not use the absorbing (vacuum), but uses extruding, that is to say the pressure effect. The station has wider and higher entrance section, in front of which the ground is covered with a black layer. At entrance section (and along the body if it is necessary) water-filled reservoirs are located, that tend to increase the station inertion. Inside of the tube electrical air heaters are situated, in order to melt the snow layer in winter. At the upper part the power plant has at least one horizontal acceleration cell (in the form of Venturi pipe) which in its turn considers to be the continuation of the body and has a narrowing transverse cross-section. And at the end it has a controlled, variable cross section nozzle (like reactive turbines). At the narrowed end of the acceleration cell there is a passing cell, at the exit of which the turbine joined to the generator is located. The station is also equipped with heat exchange (thermal energy return) system that considers to be a closed piping system having upper and lower radiators of thermal capacity fluid circuit.

### BRIEF DESCRIPTION OF DRAWINGS

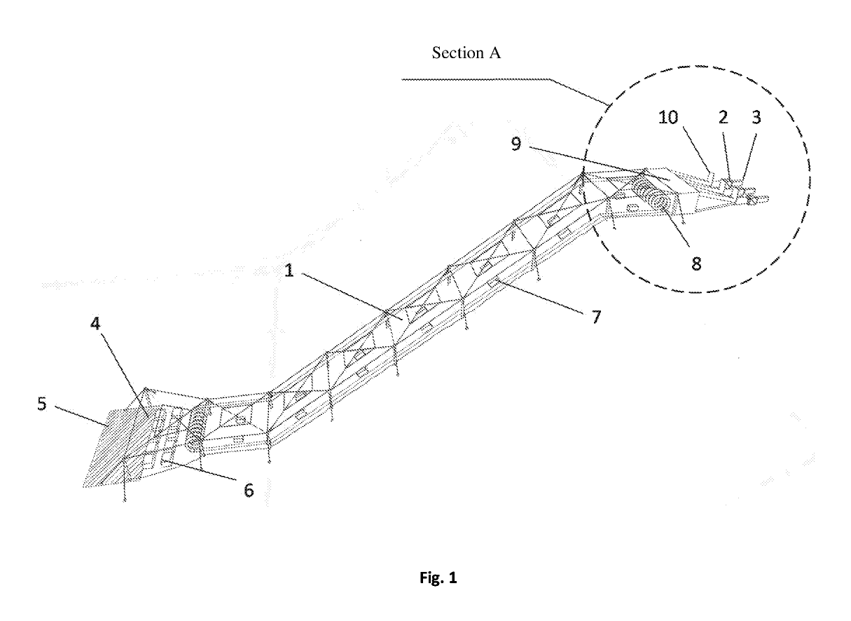

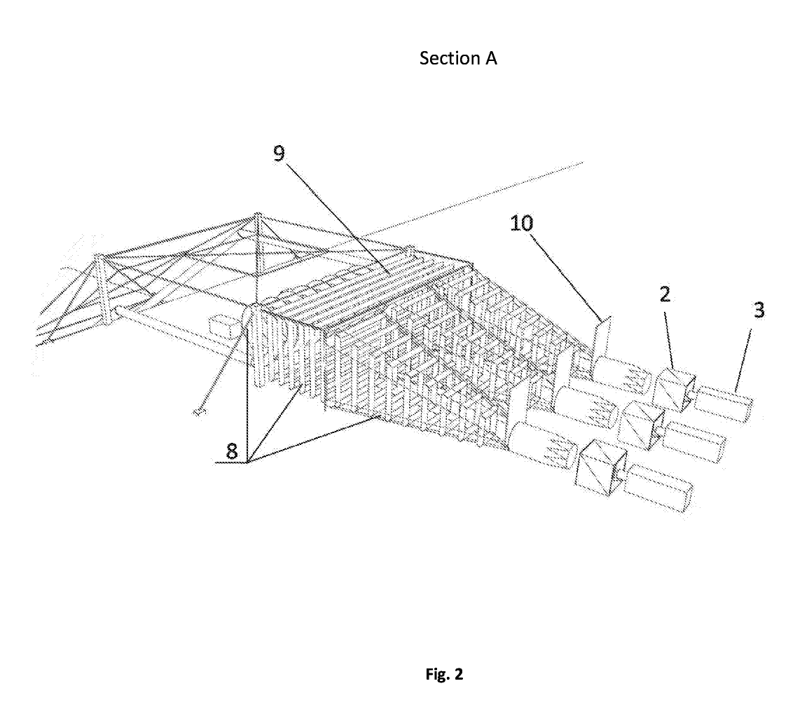

The essence of the invention is illustrated in the graph, where, in FIG. 1, the power section axonometric figure is depicted with the upper radiator located at the acceleration cell entrance, in the FIG. 2.

The axonometric picture of power plant is depicted by its upper additional radiator located around the acceleration cell.

### BEST MODE FOR CARRYING OUT THE INVENTION

The solar compression power plant has an air flow directional body (1), the surface of which is painted by matt black paint, wind turbine (2), and at least a pair of generator joined to it (3), toughly connected greenhouse to the lower edge of the lower end of the body (1), which is realized in the form of body's (1) entrance section (4). The entrance of the body (1) entrance section (4) is widened by height and width according to the the body entrance. Before greenhouse (4) the black color material layer (5) is located on the surface of the earth, and there are water-filled reservoirs (6) inside. There may be water-filled additional reservoirs (6) located along the body. The power plant additionally has electrical air heaters (7); located along the body, heat exchange system (8) and least one horizontal acceleration cell (9), which is toughly connected with the upper end of the body (1) and has a narrowing transverse cross section. The free end of acceleration cell (9) is realized in the form of controlled, variable cross section nozzle. At the narrowed end of the acceleration cell there is a passing cell (10), and at the exit of which the turbine (2) joined to the generator (3) is located. The heat exchange system (8) has a lower radiator located in the entrance section (4) of the body (1) and the upper radiator located around the acceleration cell. Lower and upper radiators are connected with each other by pipes, which are located along the body.

The body (1) (compression pipe body), in the mean time, considers to be a solar radiation receiver, air stream directional and the useful difference zone between pressures providing station workload: The pipe shape is arbitrary and depends on the opportunities provided by the area. The absence of any “dead” zone without wind is very important. A big difference in elevation between the upper and lower points is of great importance to. The mountainous terrain, in this case, has a key role. It gives an opportunity to build stations having up to the 3000 m absolute decline, which is one of the terms of providing great power and high efficiency coefficient. The slope steepness is not of great importance if does not hinder the construction.

The power station uses the difference between air heated by sun in the body (1) (compression tube) and pressures of the external environment, in order to get air mass acceleration and useful work. Wind turbines (2) and generators (3) are selected from a known list of the sphere. In specific cases when it is impossible to install turbo generators in the upper part of the station, they can be installed at the bottom. In this case the station from compressional turns into vacuum. But the vacuum station concedes to the first by its indexes due to a number of causes.
1. The transition of air mass from the low pressure zone to the high pressure zone, as well as the temperature fall, takes place inside the body, which reduces the traction force.
2. There is no acceleration cell and no additional construction is required, in order to direct the air streams to the turbines.
3. Based on safety rules the vacuum station operation is possible after construction. Yet in case of upper layout the operation can be started by one aggregate and by a part of constructed tube. It is possible to continue construction by own means. In this case the initial contribution will not exceed 30% of the total cost.
4. Etc.

The entrance section (4) is the lower part of the body (1), which is widened and is higher from the ground level, than the body (1). Widening and rising is carried out in order to increase the useful surface of the body (1), to include more extensive black coverage (from which the hot air is being absorbed in the body (1)), as well as to increase the surface pressure exerted by the external environment. The entrance section (4) widening through the body narrowing may bring to the opposite effect that is to say to the decreasing of useful surface, so the entrance section sizes are calculated individually due to the local terrain features. In order to reduce construction costs and to get additional power, the ground surface before entrance section is being covered by the black material layer (5) (plastics, sand, gravel, slag, metal sheets without pillars, etc.). The width of the black layer is being calculated individually depending on the body (1) traction characteristics.

Water filled reservoirs are meant for the collection of melting water flowing from station as well as for the collection of rainwater. They do not only increase the inertia of the power plant, but also can serve to the economic needs of the low-water areas. The water reservoirs (6) can be located along the body (1). This will allow to reduce the nominal power (savings in the cost of equipment) and significantly will increase the inertia or the working time.

Electrical air heaters (7) are used as an auxiliary means along with the solar radiation in order to melt the snow layer. The quantity and power calculation of air heaters are individual. The potential cost of electricity production forms 2-5% of annual production. Heat exchange system (cooling or thermal energy return system) (8) is a system of closed tubes, having upper and lower radiators, in which, with the help of rotating thermal capacity liquid, is being realized the return of accumulated heat to the foot. Lower radiators are being located in the entrance section (4), upper radiators are being built in the entrance section of acceleration cell (9) and/or around the acceleration cell. Heat exchange system performs dual action; for the first enables the multiple use of accumulated energy, and secondly creates a relative homogeneity of hot air distribution inside the tube, which considers to be the stable power work guarantee. The heat exchange system having high efficiency (8) is able to increase station power by more than 5 times. Since the system is being built parallel with the station construction, so the main factors of its expenses are the high-pressure pipelines and expensive, large volumes of thermal capacity liquid. However taking into account the sharp increase of the station's efficiency coefficient, one can see that as a result the cost price of installed power kilowatt is being decreased. In case of heat exchange system (8) operation, the amount of electricity used for own consumption does not exceed 5%. In principle, the power plant is also capable of working without heat exchange system (8). So, if these expenses are burdensome, the station can also be run without heat exchange system (8).

The acceleration cell (9) is designed to increase the speed of air flow, in order to ensure the maximum return of energy. To minimize the contact the acceleration cell's (9) floor is also covered with steel sheet. It is appropriate to bring it to a horizontal position, in order to overcome losses for overcoming the force of gravity. Acceleration cell (9) is built by increasing the height of body for the first, and then its cross-sectional surface gradually is being shortened. It ends with a horizontal pipe, which has the unchangeable cross -section in the beginning and at the end segment has a changeable system of cross-section like reactive turbines' nozzles. In principle the acceleration cell (9) is the Venturi pipe (it is more like a fireman water pump hose). The air speed is being increased in the acceleration cell (9). It brings to the pressure fall inside the air stream, which in its turn results the air extension and heat reduction. As a result the inner energy transformation into the kinetic energy takes place. With the help of end segment unchangeable cross-section, the pipe aims to deliver time and space, in order the inner energy parted as a result of accelerated wind current thermal fall could transform into the kinetic energy (draft wind effect). Besides this, it transforms the turbulent flow into the laminar. Since the station can work all day long (during night times it uses the heat accumulated by ground surface), so naturally the pressure and the operational regimes changes are taking place. As a result of this, in low pressure conditions an unimpeded flow of wind current may take place without an essential change of the speed. The changeable cross-section end of the nozzle has the function of regulations just of these changes, in order to reach to the maximum speed by that time. It can be controlled manually or by an automatic system. The principle; reduce or increase the cross-section so long as it increases the turbine (2) power or air speed. The maximum opening of the nozzle corresponds to the nominal power.

Passing cells (1) are designed for closing air ways for industrial or technological purposes. They give an opportunity to install the next (regular) power equipment during construction, when there is a need for them. This allows you to start the exploitation during construction, which, in its turn, reduces the initial capital investment.

The power plant is being built in sunny hillside, from steel sheets of 0,6-0,8 mm thickness coated with matt black paint.

The station is being built on hillside and using solar energy or the difference between the temperatures of the atmosphere and water reservoirs, by natural traction force; through the tube it creates a wind current which performs useful work. It consists of the system of taking energy from environment or giving the energy to environment and from the tube built from steel or insulating material, which directs the energy difference to the working part. The working parts consider to be turbo generators or water condensing radiators.

The station (equipment) operates in a following way.

The introduced mountainous compression station has a number of advantages as compared with all the other types of existing stations.

1. Ecologically clean.

2. Renewable.

3. Operational highest security.

4. Low cost-price.

5. Fast recovery of expenses.

6. Long life.

7. Great resources.

8. The lowest operating costs.

From estimated 10 m² surface, in order to receive 1 KW power, the price cost of installed power kilowatt will be 300-600 $ of USA. Annual production up to the 3000 KWh. Due to this the station self renewable period is 1-6 years. The period of construction is 1 year. First electricity is being received after two months of the construction start. Exploitation period is over 100 year. The period of operation until the new source of energy is discovered. (Calculations are introduced without the use of heat exchange system).

1. The solar compression power station, which has an air stream directional body, at least a pair of generator connected with wind turbines, tough combined greenhouse to the lower end of the body, and the external surface of the body is painted by matt black paint, is different in that the body is situated on the slope of the mountain, the greenhouse is realized in the form of body entrance section, the entrance of which toward body is widened due to the height and width. Before greenhouse the black color material layer is located on the surface of the earth, and inside there are full of water reservoirs. The power station additionally has electrical air heaters located along the body, heat exchange system and least one horizontal acceleration cell, which is toughly connected with the upper end of the body and has a narrowing transverse cross section. At the free narrowing end of the acceleration cell, a passing cell is situated, at the exit of which a generator fixed to turbine is located. Heat exchange system has a lower radiator, which is located at the body entrance section and an upper radiator, located at the acceleration cell entrance section. Lower and upper radiators are connected with each other by pipes located along the body.

2. A station according to claim 1, wherein additional water reservoirs are located along the body.

3. A station according to claim 1, wherein additional upper radiator is located around the acceleration cell.

4. A station according to claim 1, wherein the free end of acceleration cell is realized in the form of controlled, variable cross section nozzle.
